(19) United States
(12) Patent Application Publication
(10) Pub. No.: US 2012/0303927 A1
(43) Pub. Date: Nov. 29, 2012

(54) MEMORY ALLOCATION USING POWER-OF-TWO BLOCK SIZES

(76) Inventor: Richard Goldberg, Richmond, VA (US)

(21) Appl. No.: 13/114,486

(22) Filed: May 24, 2011

(51) Int. Cl. G06F 12/02

(52) U.S. Cl. 711/171; 711/E12.002

(57) ABSTRACT

Methods and systems for managing memory allocation requests are disclosed. Generally, the methods and systems relate to splitting and combining twin buffers for allocating memory of appropriate sizes in response to memory requests. One method disclosed is a method of allocating storage space in a memory of a computing system. The method includes receiving a memory allocation request, the memory allocation request defining a requested memory size, and the memory logically segmented into a plurality of blocks. The method also includes determining whether a block having a best-fit size is available from a buffer pool, the buffer pool selected from among the one or more buffer pools and defining a set of available blocks of a common size. The method includes, upon determining that no block having the best-fit size is available in the buffer pool, locating an available block from a second buffer pool from among the one or more buffer pools, the available block having a size twice the best-fit size. The method further includes splitting the available block into a pair of blocks of the best-fit size, and allocating a first of the pair of best-fit size blocks in response to the memory allocation request.

### TECHNICAL FIELD

The present disclosure relates generally to allocation of memory in a file system; in particular, the present disclosure relates to allocation of memory using power-of-two block sizes.

### BACKGROUND

Computing systems typically include a finite amount of storage space. This storage space can be provided by a main memory or mass storage facilities, such as disk arrays.

The storage facilities within a data processing system must be managed so that appropriate space may be allocated in response to request for such resource. For example, application programs may make requests for the allocation of temporary buffer space within the main memory. This buffer space may be needed as a scratch pad during program execution, or to store data that is generated by the executing application. Such data may be stored in the main memory until written to a mass storage device, or may remain located in the memory.

Generally, memory allocation functions are performed by an operating system executing on a computing system. Application programs running under the control of the operating system make requests to the operating system for a portion of memory for storage of a predetermined size. The operating system locates a location that is responsive to the request from a pool of available system resources, and assigns this storage space to the requesting application. When the application no longer requires use of the storage space, it may be returned to the operating system to be added back into the pool of available resources.

Various mechanisms have been implemented to allocate memory resources. In one example, a pool of buffers of uniform size is created. A data structure, such as a linked list, can be used to manage the pool of available buffers, for example by tracking the addresses of available buffers. In such an arrangement, each of the available buffers is a uniform size.

This arrangement of like-size buffers has disadvantages. For example, when the operating system receives a memory request that is smaller than the buffer size, the entire buffer is nevertheless allocated to that memory request, resulting in the operating system allocating more memory than is required for that particular request. As such, system resources are wasted.

One method used to overcome this issue of potentially wasted resources involves use of multiple buffer pools, with each pool representing a set of buffers having a different, uniform size. In this arrangement, a request for storage space is satisfied using the smallest buffer that is available and that can accommodate the request. If a buffer of an optimal size is not currently available, a larger buffer from a different buffer pool can be divided to create multiple smaller buffers, which are then used to populate the depleted buffer pool.

Even in this arrangement using buffer pools with different sizes of buffers, disadvantages exist. For example, it can be difficult to locate a buffer of appropriate size for use. Additionally, substantial resources may be consumed to maintain each of the buffer pools. Since often buffer pools are implemented as double-linked lists, requiring substantial updating of forward and reverse address links when each buffer is added to or removed from a buffer pool.

One solution attempting to overcome some of these issues is described in U.S. Pat. No. 6,874,062. In that arrangement, a hierarchy of bitmaps is used to manage availability of resources. In that arrangement, a higher-level bitmap is associated with a segment of bits in a lower-level bitmap, and is assigned a state that represent a collective state of the items in the segment (e.g., available, unavailable, etc.). The lower-level bitmap can then in turn be related to a further lower-level bitmap, or a block of data at a lowest level. To find a contiguous available block of memory matching a memory request, this tree structure can be traversed, with each bitmap level representing a particular size of available memory. While this arrangement allows for allocation of different block sizes, it does not provide the same level of flexibility in locating and allocating block sizes that the linked list arrangements provide.

For these and other reasons, improvements are desirable.

### SUMMARY

In accordance with the following disclosure, the above and other issues are addressed by the following:

In a first aspect, a method of allocating storage space in a memory of a computing system is disclosed. The method includes receiving a memory allocation request, the memory allocation request defining a requested memory size, and the memory logically segmented into a plurality of blocks. The method also includes determining whether a block having a best-fit size is available from a buffer pool, the buffer pool selected from among the one or more buffer pools and defining a set of available blocks of a common size. The method includes, upon determining that no block having the best-fit size is available in the buffer pool, locating an available block from a second buffer pool from among the one or more buffer pools, the available block having a size twice the best-fit size. The method further includes splitting the available block into a pair of blocks of the best-fit size, and allocating a first of the pair of best-fit size blocks in response to the memory allocation request.

In a second aspect, a method of de-allocating storage space in a memory of a computing system is disclosed. The method includes receiving an indication to free a block of allocated memory in a memory of a computing system, the block having a predetermined size, and the memory logically segmented into a plurality of blocks. The method also includes de-allocating the block of allocated memory, resulting in a free memory block. The method includes determining whether a twin block has been allocated, the twin block contiguous with and a same size as the free memory block. If the twin block is allocated, the method includes adding the free memory block to a buffer pool of available blocks of the predetermined size. If the twin block is not allocated, the method includes combining the twin block and the free memory block into a combined memory block.

In a third aspect, a memory allocation system implemented in a computing system is disclosed. The memory allocation system includes a memory addressable in a plurality of memory blocks, and programmable circuit communicatively connected to the memory and configured to execute program instructions implementing an operating system, the operating system defining a plurality of buffer pools. Each of the buffer pools is associated with available memory blocks of a common size, and each buffer pool is also associated with a different size memory block relative to other buffer pools in the plurality of buffer pools. Each memory block is tracked using a data word, the data word including data defining a usage status of the block, a size of the block, and an address.

### BRIEF DESCRIPTION OF THE DRAWINGS

FIG. 1 is a block diagram illustrating example physical details of an electronic computing device, with which aspects of the present disclosure can be implemented;

FIG. 2 is a logical diagram of a memory space in an electronic computing device, according to certain aspects of the present disclosure;

FIG. 3 is a logical diagram of a data word used to track a memory block in the memory allocation systems according to the present disclosure;

FIG. 4 is a logical diagram of a memory allocation data structure using power-of-two block sizes, according to a possible embodiment of the present disclosure;

FIG. 5 is a logical diagram of example blocks capable of being allocated in response to a memory request, according to an example implementation of the present disclosure;

FIG. 6 is a logical diagram of the example memory blocks of FIG. 5, with one block split into twin memory blocks, according to a possible embodiment of the present disclosure;

FIG. 7 is a logical diagram of the example memory block of FIG. 6, with one of the twin memory blocks split into smaller twin memory blocks, according to a possible embodiment of the present disclosure;

FIG. 8 is a logical diagram of the example memory blocks of FIG. 7, with one such block allocated for use, according to a possible embodiment of the present disclosure;

FIG. 9 is a logical diagram of the example memory blocks of FIG. 7, with a further block allocated for use, according to a possible embodiment;

FIG. 10 is a logical diagram of the example memory blocks of FIG. 7, with a third block allocated for use, according to a possible embodiment;

FIG. 11 is a logical diagram of the example memory blocks of FIG. 7, with a third block allocated for use and during the process of allocating a fourth block, according to a possible embodiment;

FIG. 12 is a logical diagram of the example memory blocks of FIG. 7, with a fourth block allocated for use, according to a possible embodiment;

FIG. 13 is a flowchart of methods and systems for allocating memory of a computing device, according to a possible embodiment of the present disclosure; and

FIG. 14 is a flowchart of method and systems for de-allocating memory of a computing device, according to a possible embodiment of the present disclosure.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to methods and systems for managing memory allocation in a computing system. The methods and systems disclosed herein relate to an arrangement in which memory blocks are tracked using one data word per memory block to describe the state of the memory block. This arrangement allows for ready tracking of the memory blocks through use of status bits, while also allowing for use of memory pools by providing a list of available block addresses managed using the memory words. With this scheme, chains can be used to link available blocks, allowing the allocation of a free block simply by getting the first item from a chain, rather than examination of a bitmap. The division of memory into power-of-two size blocks, using twinned buffers, improves the efficiency of the methods and systems of the present disclosure, as little memory is wasted and minimal fragmentation occurs across disks or other memory locations.

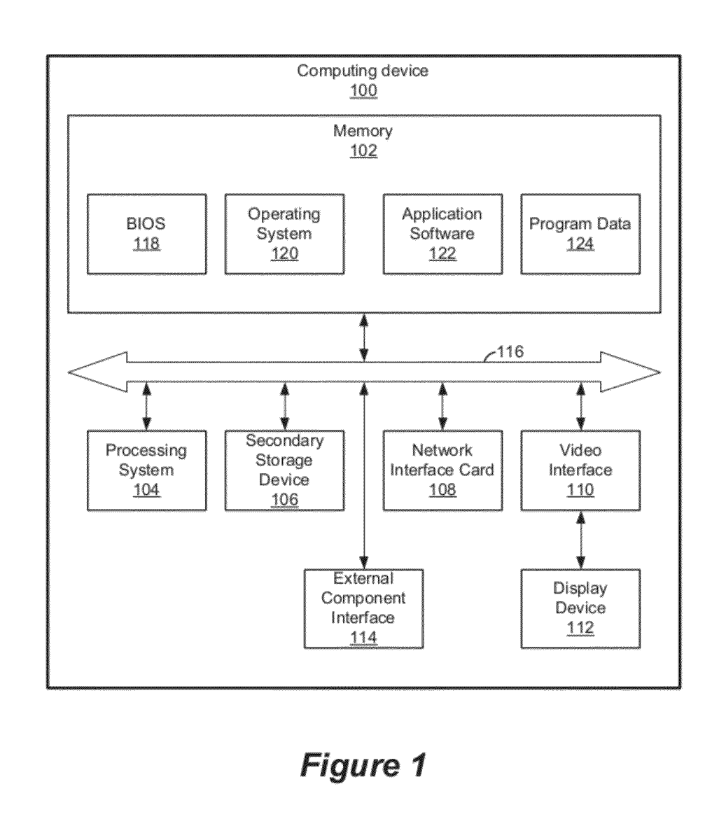

FIG. 1 is a block diagram illustrating an example computing device 100, which can be used to implement aspects of the present disclosure. In the example of FIG. 1, the computing device 100 includes a memory 102, a processing system 104, a secondary storage device 106, a network interface card 108, a video interface 110, a display unit 112, an external component interface 114, and a communication medium 116. The memory 102 includes one or more computer storage media capable of storing data and/or instructions. In different embodiments, the memory 102 is implemented in different ways. For example, the memory 102 can be implemented using various types of computer storage media.

The processing system 104 includes one or more processing units. A processing unit is a physical device or article of manufacture comprising one or more integrated circuits that selectively execute software instructions. In various embodiments, the processing system 104 is implemented in various ways. For example, the processing system 104 can be implemented as one or more processing cores. In another example, the processing system 104 can include one or more separate microprocessors. In yet another example embodiment, the processing system 104 can include an application-specific integrated circuit (ASIC) that provides specific functionality. In yet another example, the processing system 104 provides specific functionality by using an ASIC and by executing computer-executable instructions.

The secondary storage device 106 includes one or more computer storage media. The secondary storage device 106 stores data and software instructions not directly accessible by the processing system 104. In other words, the processing system 104 performs an I/O operation to retrieve data and/or software instructions from the secondary storage device 106. In various embodiments, the secondary storage device 106 includes various types of computer storage media. For example, the secondary storage device 106 can include one or more magnetic disks, magnetic tape drives, optical discs, solid state memory devices, and/or other types of computer storage media.

The network interface card 108 enables the computing device 100 to send data to and receive data from a communication network. In different embodiments, the network interface card 108 is implemented in different ways. For example, the network interface card 108 can be implemented as an Ethernet interface, a token-ring network interface, a fiber optic network interface, a wireless network interface (e.g., WiFi, WiMax, etc.), or another type of network interface.

The video interface 110 enables the computing device 100 to output video information to the display unit 112. The display unit 112 can be various types of devices for displaying video information, such as a cathode-ray tube display, an LCD display panel, a plasma screen display panel, a touch-sensitive display panel, an LED screen, or a projector. The video interface 110 can communicate with the display unit 112 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 114 enables the computing device 100 to communicate with external devices. For example, the external component interface 114 can be a USB interface, a FireWire interface, a serial port interface, a parallel port interface, a PS/2 interface, and/or another type of interface that enables the computing device 100 to communicate with external devices. In various embodiments, the external component interface 114 enables the computing device 100 to communicate with various external components, such as external storage devices, input devices, speakers, modems, media player docks, other computing devices, scanners, digital cameras, and fingerprint readers.

The communications medium 116 facilitates communication among the hardware components of the computing device 100. In the example of FIG. 1, the communications medium 116 facilitates communication among the memory 102, the processing system 104, the secondary storage device 106, the network interface card 108, the video interface 110, and the external component interface 114. The communications medium 116 can be implemented in various ways. For example, the communications medium 116 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 102 stores various types of data and/or software instructions. For instance, in the example of FIG. 1, the memory 102 stores a Basic Input/Output System (BIOS) 118 and an operating system 120. The BIOS 118 includes a set of computer-executable instructions that, when executed by the processing system 104, cause the computing device 100 to boot up. The operating system 120 includes a set of computer-executable instructions that, when executed by the processing system 104, cause the computing device 100 to provide an operating system that coordinates the activities and sharing of resources of the computing device 100. Furthermore, the memory 102 stores application software 122. The application software 122 includes computer-executable instructions, that when executed by the processing system 104, cause the computing device 100 to provide one or more applications. The memory 102 also stores program data 124. The program data 124 is data used by programs that execute on the computing device 100.

The term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

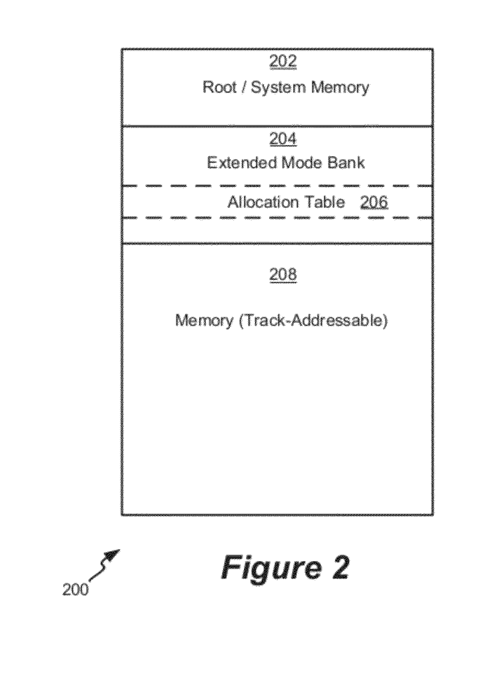

Referring now to FIG. 2, a logical diagram of a memory space 200 is illustrated. The memory space 200 can be, for example, implemented in a memory subsystem of a computing device, such as for storage on a secondary storage device 106 (e.g., a hard disk) of the electronic computing device 100 of FIG. 1. The memory space 200 includes system memory 202, which can include a variety of memory management structures and instructions, such as operating system or kernel instructions for managing memory allocation and deallocation. In the embodiment shown, the system memory 202 includes an extended mode bank 204. The extended mode bank 204 allows extended memory addresses to be accessed, as compared to a native operating system or kernel addressing, which may only use a limited number of bits for memory addressing. In other embodiments, the system memory lacks an extended mode bank, for example in systems where a native operating system and system architecture support direct addressing to each of the memory addresses available in the system.

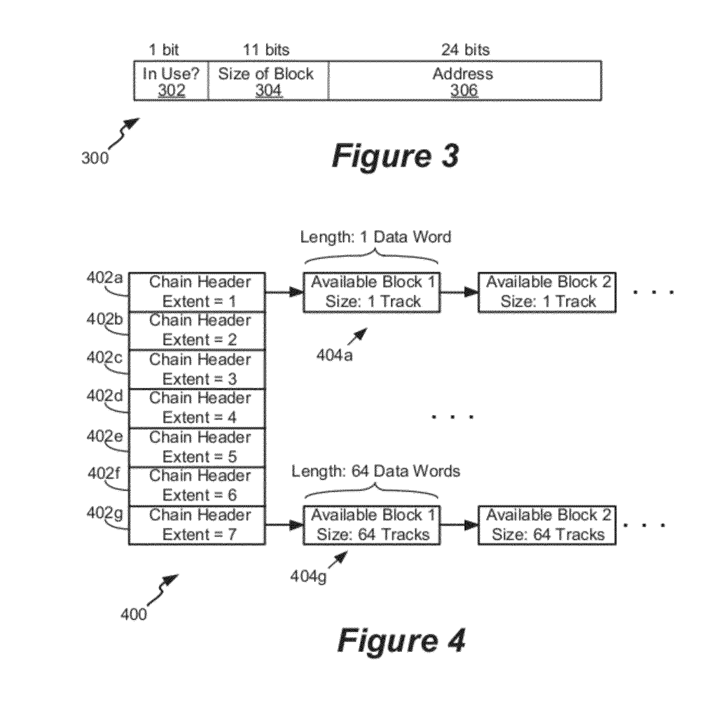

When memory is to be allocated in a computing system, for example for storing a file or other resource to disk, each partition of a file allocated using the methods and systems of the present disclosure will maintain an allocation table 206 in a portion of the extended mode bank 204, in which data words can be stored to track allocation of memory within the computing system (e.g., as illustrated in FIGS. 3-4, below). In certain embodiments, the extended mode bank 204 provides for 24 address bits capable of track-addressing, discussed in further depth below. In such an embodiment, a base register in the system memory 202 will point to the start of the allocation table 206 for a particular partition, and all addressing will be zero-relative to that base register. Other embodiments are possible as well.

The memory space 200 also includes a general use memory 208, which can be addressed in a number of different manners. In a particular embodiment, the general use memory is at least addressable at a track-level granularity, allowing the computing system to store address ranges in the allocation table 206 relating to allocated memory locations on a track-by-track (or larger granularity) basis. In accordance with the present disclosure, tracks available to be allocated for use by applications typically reside on a disk (e.g., secondary storage device 106); in certain other embodiments, the tracks can correspond to locations in the general use memory 208.

FIG. 3 is a logical diagram of a data word 300 used to monitor usage of tracks in the memory allocation systems according to the present disclosure. The data word 300 can be used, for example, in chains of a memory allocation data structure as discussed below in connection with FIG. 4. The data word 300 is, in the embodiment shown, a 32-bit word, portions of which are used to monitor an in-use status, an address, and a size of a block associated with the track. In the embodiment shown, a first bit 302 is used to track the in-use status of the track identified by the data word. A second set of bits 304 are used to define a size of the block associated with that track. In the embodiment shown, the second set of bits is 11 bits in length, although in other embodiments, additional bits could be used, depending upon the maximum and minimum sizes of blocks to be addressed within the system. In an embodiment using 11 bits, one possible arrangement allows for allocating memory in sizes between 1-64 tracks. Using only powers-of-two for block sizes, these sizes are defined by an “extent” which identifies the particular block size used. The “extent” is defined to be log₂ (size)+1, according to the following arrangement:

| Extent | Block Size |
|---|---|
| 1 | 1 TRK |
| 2 | 2 TRK |
| 3 | 4 TRK |
| 4 | 010 = 8 TRK |
| 5 | 020 = 16 TRK |
| 6 | 040 = 32 TRK |
| 7 | 0100 = 64 TRK |

In addition to the first bit 302 and second bits 304, a set of third bits 306 are used to store an address. The address will be, for example, an address of a next available block, if that block is not currently allocated and in use (i.e., is part of a chain of available blocks), and undefined if the block is in use.

It is noted that the above block size representations are in this embodiment (as well as in the following discussion) illustrated as octal numbers, with each digit representing three binary positions; in other embodiments, different representations (e.g., decimal or hexadecimal) could be used as well.

Referring now to FIG. 4, an example illustration of a memory allocation data structure 400 using power of two block sizes is shown according to a possible embodiment of the present disclosure. Generally, the present disclosure allows for allocating blocks of memory of various sizes, and matching memory allocation requests to a “best fit” block size, representing a block size capable of fulfilling the memory allocation request without allocating more memory than would be required in response. Generally, the data structure 400 includes a set of headers 402a-g which represent an access point to memory pools 404a-g. In other words, each header 402 is the start of a chain of available memory blocks of an identified size, and points to a first block in the chain of that size. Each memory pool is also referred to herein as a chain of available memory blocks of a particular size, or buffer pool.

In the particular embodiment shown in FIG. 4, blocks of sizes 1-64 tracks are provided, with each subsequent memory pool representing blocks of twice the size of blocks in a previous pool. In other words, a first memory pool 404a represents a chain of available blocks having a size of one track, which can be reached by accessing the header 402a associated with that memory pool. A second memory pool 404b represents a set of available blocks having a size of two tracks, and are accessible via header 402b. Likewise, the remaining memory pools 404c-g can be accessed via headers 402c-g.

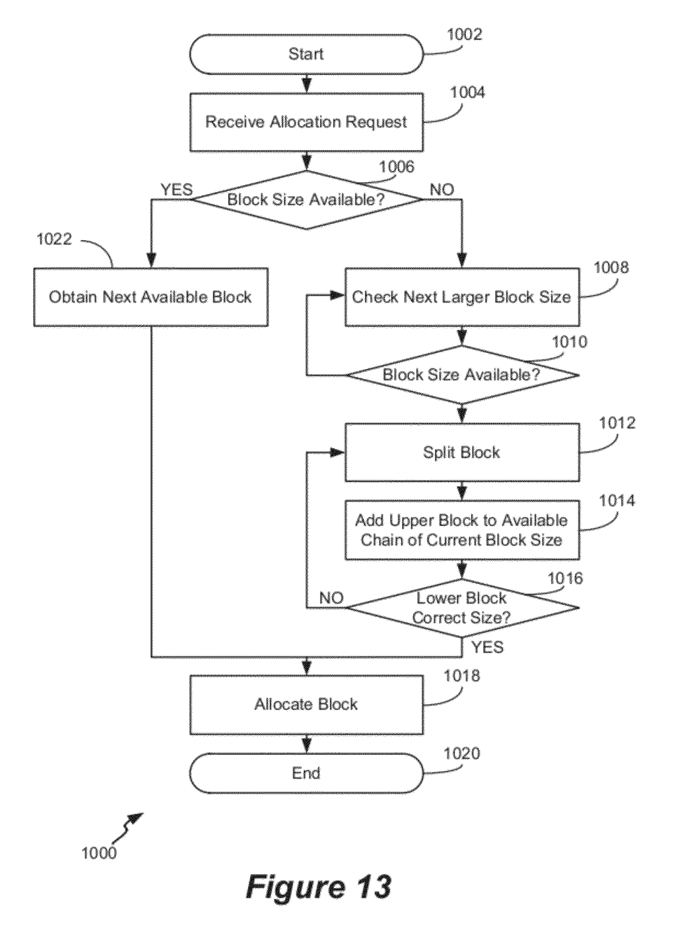

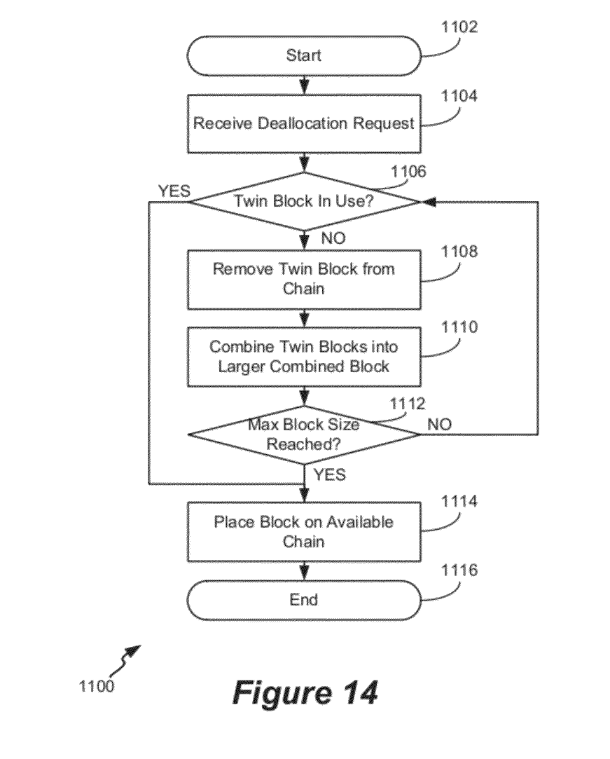

In various embodiments, and as further discussed below in connection with FIGS. 13-14, memory allocation and memory pool management schemes can be employed using the data structure 400 to maintain available memory blocks in as large a block size as possible. In connection with the embodiment shown, a 64 track block size represents the maximum block size supported; however, in alternative embodiments, a different maximum block size could be used. In the embodiments described herein, each block smaller than 0100=64 tracks will have a contiguous twin block of the same size. As such, in this embodiment, 64 track blocks will be maintained as much as possible, but can be split into twin blocks of half that size as required (with each of those blocks capable of being subsequently split into still smaller blocks until a best-fit size is reached.

For example, at initialization time, a size 0100 block at address 0000 will have a size 0100 twin block at address 0100, and the size 0100 block at address 0200 will have a size 0100 twin block at address 0300. If a request is made for a size 040 block (i.e. 32 track block size), the size 0100 block at address 0000 can be split into twin size 040 blocks at addresses 0000 and 0040, and lower-addressed block 0000 can be allocated in response to that request. If instead a request is made for a size 020 block (16 track block size), the size 040 block at address 0000 can be further split into twin size 020 blocks at addresses 0000 and 0020, and the lower-addressed block 0000 (now representing a 16 track block) can be allocated in response to the request. When blocks are released, they are combined with their twin block, if it is unused, to make a larger power-of-two size block. This block combining process continues repeatedly until an in-use twin is found, or a size 0100 block has been created.

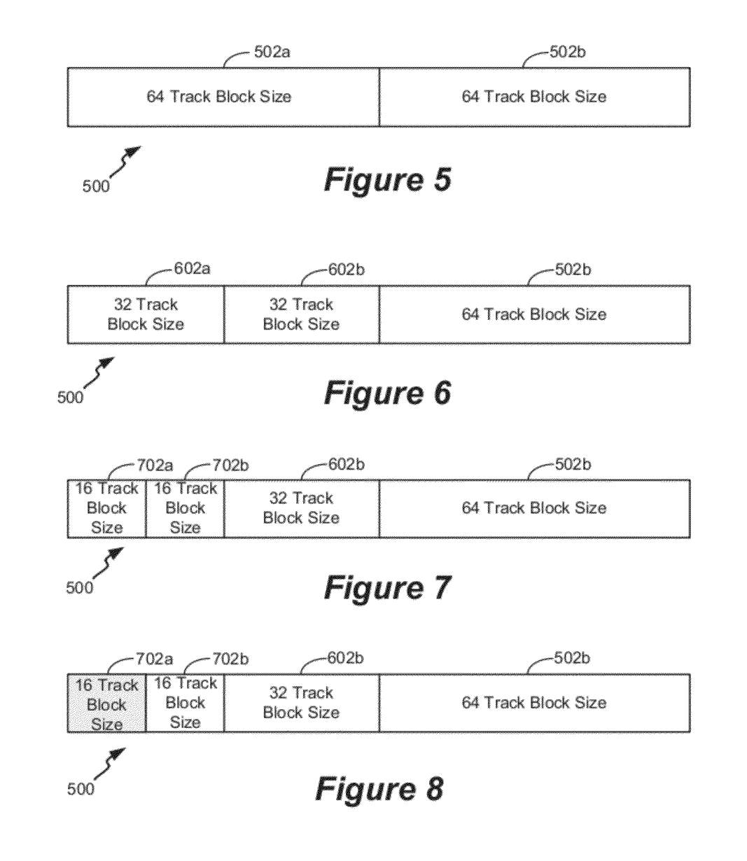

Referring now to FIGS. 5-12, an example implementation of the present disclosure in which the above example block allocation and deallocation processes is illustrated. FIGS. 5-8 specifically illustrate an example configuration of memory blocks occurring when a 16 track block is requested in an operating system of a computing system such as the one illustrated above in connection with FIG. 1. FIG. 5 represents an initial memory state in which a portion of a memory space 500 includes two available 64 track blocks 502a-b. Each of these blocks will be added to a chain of blocks included in a memory pool, such as the one described above in connection with FIG. 4 (i.e. in memory pool 404g). This can be accomplished, for example, by updating a header 404g to point to the starting address of block 502b. One or more of the data words associated with that block 502b can also be updated to include the address of block 502a, which represents the second (and most readily available) block of that size. Although only two blocks are illustrated, it is recognized that more blocks will typically exist in a particular memory; in fact, hard disk memory structures typically include a very area of memory that can be allocated, and as such will include a large number of such blocks. However, for ease of illustration, two blocks are shown.

It is noted that if a memory request is for a space in memory at least as large as one of the maximum size blocks, the computing system can allocate contiguous memory blocks, as discussed in further detail below.

FIG. 6 represents a first splitting of a 64 track block into two 32 track blocks in response to a memory allocation request defining a size that is equal to or smaller than 32 tracks in memory (in the case of this example, a 16 track block). In the embodiment shown, assuming there are no available 16 track blocks in memory pool 404e and no 32 track blocks in memory pool 404f, the lower-addressed 64 track block 502a is split into 32 track blocks 602a-b. However, in alternative embodiments, a higher-addressed block (e.g., block 502b) could be split instead. In conjunction with splitting block 502a into blocks 602a-b, block 502a is removed from the 64 track block memory pool (e.g., pool 404g of FIG. 4), and blocks 602a-b are added to the 32 track block memory pool (e.g., pool 404f of FIG. 4), with the data words associated with the tracks forming block 502a updated to reflect the changed size and address information reflected by splitting into blocks 602a-b.

FIG. 7 represents a second splitting of the original 64 track block 502a of FIG. 5 in response to the memory allocation request, such that the first 32 track block 602a is further split into two 16 track blocks 702a-b. In conjunction with splitting block 602a into blocks 702a-b, block 602a is removed from the 32 track block memory pool (e.g., pool 404f of FIG. 4), and blocks 702a-b are added to the 16 track block memory pool (e.g., pool 404e of FIG. 4). At this point, if the data structure 400 of FIG. 4 is used, memory pool 404g will contain a number of 64 track blocks (including at least block 502b), memory pool 404f will contain a 32 track block 602b, and memory pool 404e will contain two 16 track blocks 702a-b. The data words for blocks 702a-b (i.e. 16 data words per block) could then be updated to reflect updated size and address information relating to movement of those blocks to a new memory pool.

Because a 16 track block matches a size of memory in the received request for memory allocation, one of these blocks (illustrated in FIG. 8 as block 702a) is allocated, and that block is removed from the memory pool for 16 track blocks (e.g., memory pool 404e of FIG. 4). The data word for block 702a would be updated to reflect that it is in use, and to store the address of the cache buffer associated with the block in use.

It is noted that, if in response to a memory allocation request it is determined that an available 16 track block or 32 track block is available in memory pools 404e-f, a 64 track block need not be split. Instead, an available 16 track block could be used, or an available 32 track block could be split into two 16 track blocks for use. Additionally, in certain embodiments, data words are not updated until the appropriate-sized blocks have been formed, thereby reducing the overhead of updating a particular data word multiple times for a single allocation (e.g., if the data word is associated with a track that is part of multiple block-splitting operations in association with a particular memory allocation).

If a deallocation request is received by the operating system, the reverse process is performed, with the memory block 702a being returned to a memory pool 404e (as shown in FIG. 7). Because its contiguous “twin” memory block 702b is free, the two blocks are combined and removed from memory pool 404e, and a new entry is made in the chain represented by memory pool 404f (32 track block size), represented in FIG. 6. This new 32 track block can be combined with a free contiguous block, to reform a 64 track block (e.g., as in FIG. 5). If one or more of the adjacent blocks are not free (i.e., have subsequently been allocated), then the combining process will not occur with respect to that used block, and the deallocated memory will simply remained tracked within a memory pool, representing smaller block sizes (e.g., the 16 track block size memory pool 404e or the 32 track block size memory pool 404f).

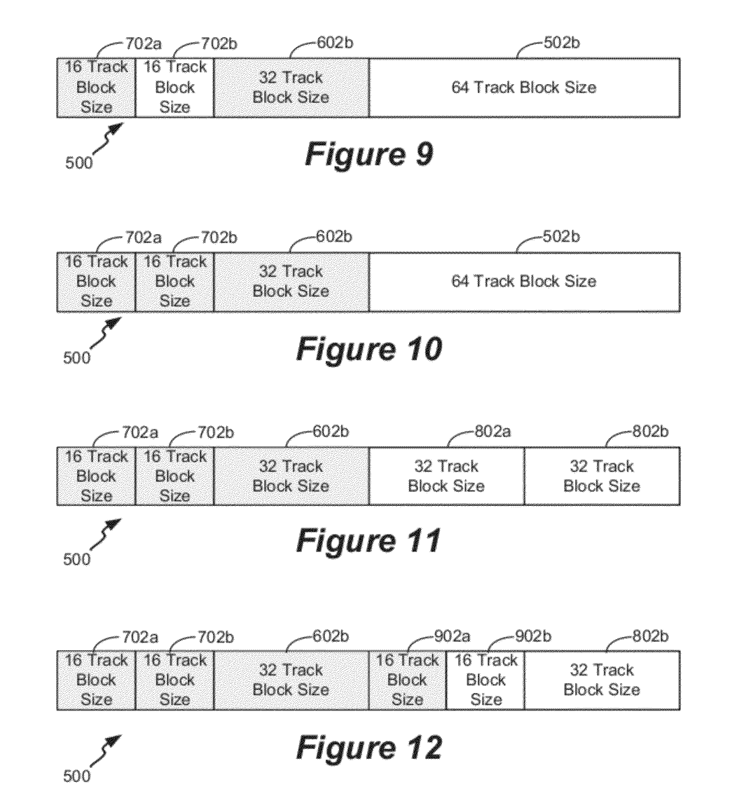

Continuing the example of FIGS. 5-8, FIGS. 9-12 illustrate additional block allocations, according to a possible embodiment of the present disclosure. FIG. 9 represents a subsequent allocation of a 32 track block size memory block, following the 16 track allocation of FIG. 8. In this example, block 602b is allocated, and removed from memory pool 404f, leaving memory blocks 502b and 702b as free memory blocks within pools 404f and 404e, respectively. FIG. 10 represents another subsequent allocation, this time of a 16 track block size memory block, following the allocation of FIG. 9. In this example, memory block 702b is allocated in response to this request, and removed from the 16 track block size memory pool 404e.

FIGS. 11-12 represent allocation of a further 16 track memory block following the allocations of FIGS. 8-10. Because no remaining 16 track or 32 track memory blocks are available (unless one of blocks 702a-b or block 602b is freed prior to receipt of the allocation request), there exists no free 16 track block or 32 track block in memory pools 404e-f. Accordingly, in FIG. 11, block 502b is split into a pair of twin 32 track blocks 802a-b and added to memory pool 404f (while 502b is removed from memory pool 404g). In FIG. 12, one of the twin 32 track blocks (illustrated as block 802a) is split into blocks 902a-b and added to the 16 track block memory pool 404e, while block 802a is removed from the 32 track block memory pool 404f. One of these blocks, shown as block 902a in the embodiment shown, is then allocated in response to the request.

Regarding deallocation, if block 902a is to be freed, a reverse operation can occur, reforming a 64 track size block 502b based on repeatedly combining free, twinned, smaller blocks in a reversed process. In contrast, if for example only block 702b is freed, no combining could occur, because there is no adjacent, contiguous twin memory block available to be combined with that block (for example, since neighboring block 702a is allocated).

Referring now to FIGS. 13-14, methods and systems for allocating and deallocating memory in a computing system are described generally, in accordance with the examples and structures described above. FIG. 13 is a flowchart of methods and systems 1000 for allocating memory of a computing device, according to a possible embodiment of the present disclosure, while FIG. 14 is a flowchart of method and systems 1100 for de-allocating memory of a computing device.

In FIG. 13, the methods and systems for allocating memory are instantiated at a start operation 1002, which corresponds to initial boot-up or operation of a kernel or operating system, to the extent that it becomes prepared to receive and/or manage memory allocation requests from processes or applications executing on the computing system. An allocation request operation 1004 receives an allocation request that defines a particular size of memory requested, and a requesting process. The allocation request operation 1004 also determines a best-fit memory block size that can be allocated to respond to the request. In one example embodiment, the operating system determines a best-fit size memory block by finding a size equal to or larger than the requested memory size, where one half of the best-fit size is smaller than the requested memory size. This represents the memory block that can fit the allocated memory request within it, but cannot be subdivided to prevent additional wasted memory space.

In certain embodiments, a best-fit block corresponds to a block matching a size of a memory allocation request. In such embodiments, applications are limited to requesting memory of predetermined sizes, for example a size corresponding to one of the seven block allocation sizes described herein (1-64 track block sizes of doubling size).

The operating system performs an availability determination operation 1006 to determine if a best-fit block size is available to fulfill the allocation request. If the memory pool associated with the best-fit block size is empty, operational flow proceeds to a larger block size operation 1008, which adjusts the operating system to assess the availability of the next-larger sized block. A next block availability determination operation 1010 determines whether a next-larger block is available for allocation by assessing whether such a block is available in a memory pool associated with that next-larger block size. If no block is available at that next-larger block size, operational flow returns to the larger block size operation 1008 to adjust to a still larger block size. This loop will continue until an available block is found in a buffer pool, up to a maximum block size available as defined by the operating system.

If a block is available at a next-larger block size, a block splitting operation 1012 splits that block into two equal sized, contiguous twin blocks. A buffer pool update operation 1014 adds the upper block to the memory pool of the next smaller size, and removes the block being split from its current memory pool. A lower block size determination operation 1016 determines whether the lower-addressed block from the split twin blocks is the correct, best-fit size. If it is not yet the correct best-fit size, operational flow returns to the block splitting operation 1012, to recursively reach the best-fit size through execution of the block splitting operation and the memory pool update operation 1014 until that best fit operation is reached. If the block is in fact the best-fit size, a block allocation operation 1018 allocates the block in response to the request. An end operation 1020 completes the allocation procedure.

Referring back to the availability determination operation 1006, if a best-fit sized block is available in a memory pool, a next available block operation 1022 obtains a next available block from the memory pool of best-fit sized blocks. Operational flow proceeds to the block allocation operation 1018, which allocates the block in response to the request, and the end operation 1020 completes the allocation procedure.

It is noted that the memory allocation request can in some embodiments define a size larger than the maximum block size (e.g., 64 track block size) available in a given implementation. In such a case, the best-fit size would correspond to the maximum block size. The availability determination operation 1006 will, in this case, search for a set of contiguous, maximum-size buffers that would satisfy the memory allocation request (e.g., by collecting a set of contiguous 64 track block size buffers). This can be accomplished by traversing the chain of data words associated with the 64 track blocks to find buffers having addresses of next-available blocks that are positioned 64 tracks away from that current available data word. Using the extents and block sizes discussed above, adjacent maximum size blocks would have addresses 0100 apart. Deallocation of such memory allocations with larger-than-maximum size blocks can occur individually (i.e., on a block-by-block basis). In certain embodiments of the present disclosure, data words are allocated from a lowest-available address range and available block chains are maintained in ascending address order (e.g., as illustrated in FIGS. 5-8); in such embodiments, locating such larger-than-maximum blocks can be readily performed.

Referring now to FIG. 14, a flowchart of method and systems 1100 for de-allocating memory of a computing device, according to a possible embodiment of the present disclosure. A start operation corresponds to operation of a kernel or operating system, and previous allocation of at least one memory block according to the methods and systems described herein. A deallocation request receipt module 1104 corresponds to receipt at the operating system of a request to free a particular block in memory, for example upon its completed use by an application. The deallocation request receipt module 1104 also corresponds to updating a word defining that block to indicate that the block is free (not in use).

A twin block assessment operation 1106 determines whether the twin block to that block to be deallocated is free. To do so, the twin block must be located. A variety of algorithms can be used to locate a twin block. For example, in certain embodiments, every block smaller than 0100=64 tracks, by design, will have a corresponding twin block. To locate the twin block of a particular block, the block's address and the block's size can be “AND-ed” to determine whether the block in question is the lower or upper block of a pair of twin blocks: if the result is zero, then the block is the lower-addressed twin, and its twin is located at address+size; if the result is non-zero, then the block is the upper-addressed twin, and its twin is at address−size.

If the twin block is not in use, a twin block removal operation 1108 removes the twin block from its memory pool. A block combination operation 1110 combines the freed block identified in the deallocation request receipt module 1104 with its free twin block, to form a block of double that size. A maximum size operation 1112 determines whether a maximum size block size has been reached as a result of the combination of the block and its twin. In certain embodiments, the maximum size operation 1112 determines whether the resulting combined block has reached a 64 track size block. If the resulting combined block has not yet reached a maximum block size, operational flow returns to the twin block assessment operation 1106, to recursively assess whether further combinations are possible.

If the resulting combined block has reached a maximum block size, or if no combination of blocks is possible (as determined initially at the twin block assessment operation 1106), operational flow proceeds to a memory pool update operation 1114, which places the resulting new block on a chain (in combination or alone) in the appropriate memory pool based on the size of the block. An end operation corresponds to completed deallocation of the memory block, such that it can be subsequently allocated by another allocation request (e.g., as described in connection with FIG. 13).

As illustrated in FIGS. 5-12 and described in connection with FIGS. 13-14, it is recognized that lower-addressed blocks are generally allocated prior to allocation of higher-addressed blocks. This provides a number of advantages. For example, by keeping the buffers on the available chain in address order, the systems and methods of the present disclosure will use and reuse memory at the low addresses more frequently than those at higher addresses, reducing disk and other memory fragmentation problems that may affect performance. Additionally, when blocks are combined during deallocation, the twin block must be dequeued from its available chain. In order to locate that block on the chain, it is necessary to “chase” through the chain. By keeping the chain in address order and always allocating the lowest addresses, the resources involved in chasing the chain to find a twin buffer are kept to a minimum. However, other implementations are possible in which lower-addressed blocks are reserved or are not allocated before higher-addressed blocks.

The above specification, examples and data provide a complete description of the manufacture and use of the composition of the invention. Since many embodiments of the invention can be made without departing from the spirit and scope of the invention, the invention resides in the claims hereinafter appended.

1. A method of allocating storage space in a memory of a computing system, the method comprising:
receiving a memory allocation request, the memory allocation request defining a requested memory size, and the memory logically segmented into a plurality of blocks;
determining whether a block having a best-fit size is available from a buffer pool, the buffer pool selected from among the one or more buffer pools and defining a set of available blocks of a common size;
upon determining that no block having the best-fit size is available in the buffer pool, locating an available block from a second buffer pool from among the one or more buffer pools, the available block having a size twice the best-fit size;
splitting the available block into a pair of blocks of the best-fit size; and
allocating a first of the pair of best-fit size blocks in response to the memory allocation request.

2. The method of claim 1, wherein locating an available block from a second buffer pool comprises:
locating a second available block from a third buffer pool from among the one or more buffer pools, the second available block being twice the size of the available block;
splitting the second available block into a pair of blocks; and
adding the pair of blocks to the second buffer pool, wherein one of the pair of blocks corresponds to the available block.

3. The method of claim 1, further comprising associating a data word with each of the pair of blocks of the best-fit size, the data word including data defining the best-fit size.

4. The method of claim 1, further comprising, prior to allocating the first of the pair of best-fit size blocks, adding the pair of best-fit size blocks to the buffer pool.

5. The method of claim 1, further comprising, prior to receiving the memory allocation request, creating a first pool of available blocks in the memory, each of the available blocks having a first predetermined size.

6. The method of claim 1, wherein the best-fit size corresponds to a size equal to or larger than the requested memory size, and wherein one half of the best-fit size is smaller than the requested memory size.

7. The method of claim 6, wherein each block is represented by a data word, the data word including data defining a usage status of the block, a size of the block, and an address.

8. The method of claim 7, wherein the address is an address of the next available block in the buffer pool containing the block.

9. The method of claim 7, wherein the address is an address of the cache buffer.

10. The method of claim 1, wherein the memory allocation request is a request for space on a disk drive of the computing system.

11. A method of de-allocating storage space in a memory of a computing system, the method comprising:
receiving an indication to free a block of allocated memory in a memory of a computing system, the block having a predetermined size, and the memory logically segmented into a plurality of blocks;
de-allocating the block of allocated memory, resulting in a free memory block;
determining whether a twin block has been allocated, the twin block contiguous with and a same size as the free memory block;
if the twin block is allocated, adding the free memory block to a buffer pool of available blocks of the predetermined size; and
if the twin block is not allocated, combining the twin block and the free memory block into a combined memory block.

12. The method of claim 11, further comprising, upon combining the twin block and the free memory block into a combined memory block, adding the combined memory block to a buffer pool of available blocks of a common size, the common size being twice the predetermined size of the free memory block.

13. The method of claim 11, further comprising, upon combining the twin block and the free memory block into a combined memory block, determining whether a second twin block has been allocated, the second twin block contiguous with and a same size as the combined memory block.

14. The method of claim 13, further comprising combining the second twin block and the combined memory block into a second combined memory block having a size twice that of the combined memory block.

15. The method of claim 14, further comprising adding the second combined memory block to a buffer pool of available blocks of a common size, the common size four times larger than the predetermined size of the free memory block.

16. A memory allocation system implemented in a computing system, the memory allocation system comprising:
a memory addressable in a plurality of memory blocks;
a programmable circuit communicatively connected to the memory and configured to execute program instructions implementing an operating system, the operating system defining a plurality of buffer pools,
each buffer pool associated with available memory blocks of a common size,
each buffer pool associated with a different size memory block relative to other buffer pools in the plurality of buffer pools;
wherein each memory block is tracked using a data word, the data word including data defining a usage status of the block, a size of the block, and an address.

17. The memory allocation system of claim 16, wherein the operating system is programmed to:
receive a memory allocation request, the memory allocation request defining a requested memory size;
determine whether a memory block having a best-fit size is available from one of the plurality of buffer pools;
upon determining that no block having the best-fit size is available in the buffer pool, locate an available block from a second buffer pool from among the one or more buffer pools, the available block having a size twice the best-fit size;
split the available block into a pair of blocks of the best-fit size; and
allocate a first of the pair of best-fit size blocks in response to the memory allocation request.

18. The memory allocation system of claim 17, wherein the operating system is further programmed to:
receive an indication to free a block of allocated memory, the block having a predetermined size,
de-allocate the block of allocated memory, resulting in a free memory block;
determine whether a twin block has been allocated, the twin block contiguous with and a same size as the free memory block;
if the twin block is allocated, add the free memory block to a buffer pool of available blocks of the predetermined size; and
if the twin block is not allocated, combine the twin block and the free memory block into a combined memory block.

19. The memory allocation system of claim 17, wherein the best-fit size corresponds to a size equal to or larger than the requested memory size, and wherein one half of the best-fit size is smaller than the requested memory size.

20. The memory allocation system of claim 17, wherein the pair of blocks of the best-fit size are equal in size to each other.

21. The memory allocation system of claim 16, wherein the address is an address of the next available block in the buffer pool containing the memory block tracked by the data word.22. The memory allocation system of claim 16, wherein the memory comprises a memory of a hard disk drive.
